(19) United States
(12) Patent Application Publication
(10) Pub. No.: US 2008/0215169 A1
(43) Pub. Date: Sep. 4, 2008

(54) Audio System

(76) Inventors: Lisa deBettencourt, Lowell, MA (US); Damian Howard, Winchester, MA (US); Trevor Irving Lai, Ashland, MD (US); Steffen Lang, Framingham, MA (US); Jed R. Wood, Clinton, MA (US); Kenneth S. Yoshioka, Sutton, MA (US)

Correspondence Address: FISH & RICHARDSON PC, P.O. BOX 1022, MINNEAPOLIS, MN, 55440-1022, US

(21) Appl. No.: 11/681,646

(22) Filed: Mar. 2, 2007

(51) Int. Cl. G06F 17/00; H04B 1/00

(52) U.S. Cl. 700/94; 381/86

(57) ABSTRACT

A method of selecting an audio source includes the step of providing an audio system that includes a source of audio data which can be supplied to a speaker to produce sound. A portable audio source device is enabled to be operatively connected to the audio system. When the portable audio source device is operatively connected to the audio system, the audio system automatically stops supplying audio data from the source of audio data to the speaker and starts supplying audio data from the portable audio source device to the speaker to produce sound.

### BACKGROUND

This disclosure relates to methods and apparatus for playing audio information and for presenting metadata on a display.

### SUMMARY

According to a first, aspect of the invention, method of selecting an audio source includes the step of providing an audio system that includes a source of audio data which can be supplied to a speaker to produce sound. A portable audio source device is enabled to be operatively connected to the audio system. When the portable audio source device is operatively connected to the audio system, the audio system automatically stops supplying audio data from the source of audio data to the speaker and starts supplying audio data from the portable audio source device to the speaker to produce sound.

The portable audio source device can be operatively connected to the audio system with as electrical conductor. The portable audio source device can be operatively connected to the audio system wirelessly. The audio system can include a head unit for an automobile infotainment system. The source of audio data, can be selected from one of FM, AM, satellite radio, CD, DVD, hard drive and navigation system. The portable audio source device can be an iPod®.

According to a further aspect of the invention, a method of downloading metadata, includes the steps of providing an audio system and enabling a portable audio source device to be operatively connected to the audio system. When the portable audio source device is operatively connected to the audio system, metadata stored on the portable audio source device is automatically downloaded to the audio system.

The downloaded metadata can be stored in a volatile memory of the audio system. The volatile memory can be random access memory. The downloaded metadata can be stored in a non-volatile memory of the audio system. The non-volatile memory can be a hard disk drive. Downloaded metadata that is saved by the audio system is not re-downloaded when the portable device is disconnected from the audio system and then again operatively connected to the audio system. Downloaded metadata that is saved by the audio system is not re-downloaded when it is determined that the metadata stored on the portable device has not changed from when the portable device was connected to the audio system to when the portable device was next connected to the audio system.

According to a further aspect of the invention, a method of presenting metadata includes the steps of providing an audio system that includes a display and enabling a portable audio source device to be operatively connected to the audio system. After the portable audio source device is operatively connected to the audio system, metadata for audio tiles stored on die portable audio source device is presented on a display of the audio system in a format which is different from a format in which the metadata is displayed on a display of the portable audio source device.

The metadata presented on the portable device display lists the name of each artist but does not list the name of an album for each artist, whereas the metadata presented on the audio system display lists the name of each artist and lists the name of the album for each artist. The metadata presented on the portable device display does not list the total number of albums stored on the portable device, whereas the metadata presented on the audio system display lists the total number of albums stored on the portable device. The metadata presented on the portable device display does not list an order of a selected album among a total number of albums stored on the portable device, whereas the metadata presented on the audio system display lists the order of a selected album among the total number of albums stored on the portable device.

The metadata presented on the portable device display lists the name of each track on an album but does not list the name of an artist for that album, whereas the metadata presented on the audio system display lists the name of each track on the album and lists the same of the artist for that album. The metadata presented on the portable device display does not list the total number of tracks on the album, whereas the metadata presented on the audio system display lists the total number of tracks on the album. The metadata presented on the portable device display does not list an order of a selected track among a total number of tracks on the album, whereas the metadata presented on the audio system display lists the order of a selected track among the total number of tracks on the album.

The metadata presented on the portable device display lists the name of each track stored on the portable device but does not list the name of an artist for a selected one of the tracks, whereas the metadata presented on the audio system display lists the name of each track stored on the portable device and lists the name of the artist for the selected track. The metadata presented on the portable device display does not list the total number of tracks stored on the portable device, whereas the metadata presented on the audio system display lists the total number of tracks stored on the portable device. The metadata presented on the portable device display does not list an order of a selected track among a total number of tracks stored on the portable device, whereas the metadata presented on the audio system display lists the order of a selected track among the total number of tracks stored on the portable device.

According to a still further aspect of the invention, a method of presenting metadata includes the steps of providing an audio system that includes a display and enabling a portable audio source device to be operatively connected to the audio system. After the portable audio source device is operatively connected to the audio system, metadata associated with an audio file stored on the portable audio source device and metadata associated with, an audio file stored on the audio system are simultaneously presented on the display.

An indicator can be provided on the display for a particular piece of metadata that indicates whether an audio file associated with that metadata is stored on the portable device, or whether the audio file is stored on the audio system. Metadata for audio files stored on the portable device is stored on the audio system in a non-volatile memory of the audio system. The non-volatile memory can be a hard disk drive.

According to yet another aspect of the invention, an audio system includes a storage device for digitally storing a first plurality of songs and metadata associated with each of the first plurality of songs. An interface unit is provided for interfacing with a portable audio source device having a second plurality of songs and metadata associated with each of the second plurality of songs. A user interface is configured to present a single menu that allows a user to select a song from either the first or second plurality of songs without having to change source selection.

An indicator can be provided on a display of the user interface for a particular piece of metadata that indicates whether an audio file associated with that metadata is stored on the portable device, or whether the audio file is stored on the storage device. Metadata for audio files stored on the portable device is stored on the storage device in a non-volatile memory. The non-volatile memory can be a hard disk drive.

According to another aspect of the invention, an audio system includes a storage device for digitally storing a first plurality of songs and metadata associated with each of the first plurality of songs. An interface unit is provided for interfacing with a portable audio source device having a second plurality of songs and metadata associated with each of the second plurality of songs. A song selection module is configured to playback songs from either the first or second plurality of songs without user input.

The song selection module randomly selects songs from among the first and second plurality of songs. The song selection module intelligently selects songs from among the first and second plurality of songs.

### BRIEF DESCRIPTION OF THE DRAWINGS

FIG. 1 is schematic view of an audio system and a portable audio source device;

FIG. 2 is a schematic view of a portable device operatively connected to the audio system;

FIG. 3 is a schematic view of an audio system showing metadata from a portable device half downloaded to the audio system;

FIG. 4 is a schematic view of an audio system showing metadata from a portable device completely downloaded;

FIG. 5 is a schematic view of the audio system presenting artist/album information;

FIG. 6 is a schematic view of an audio system presenting tracks on a particular album;

FIG. 7 is a schematic view of an audio system presenting tracks in alphabetical order; and

FIG. 8 is a schematic view of an audio system presenting artist/album information from both the audio system and the portable device.

### DETAILED DESCRIPTION

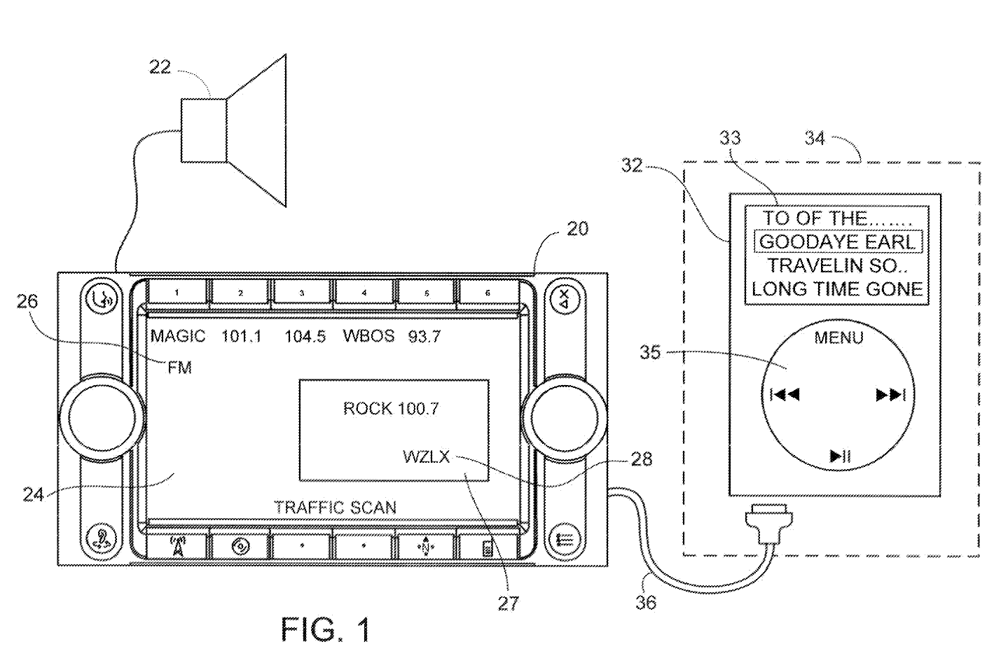

Referring to FIG. 1, an audio system 20 is a head unit for a car infotainment system. However, in other implementations, the audio system may be a home, commercial, and/or portable audio system. System 20 includes a number of internal sources of audio data including FM, AM and satellite radio tuners, a CD/DVD drive (not shown), a hard disk drive for storing audio content, and a navigation system. The system also includes the ability to render audio delivered from external audio sources such as a mobile telephone and a personal audio device.

Each of these sources can be used to provide audio data which can be supplied to a speaker 22 (or set of speakers) to produce sound. The hard disk drive acts as a storage device for digitally storing music files (e.g., mp3 files) and metadata associated with these files. In some implementations, the hard drive may store other content such as contact information (e.g., names, addresses, telephone numbers, etc), digital images (e.g., digital photos) and digital video content. Further features of audio system 20 are described in U.S. patent applications Ser. No. 11/317,558 (filed Dec. 22, 2005), Ser. No. 10/626,349 (filed Jul. 23, 2003), Ser. No. 10/956,836 (filed Oct. 1, 2004), and Ser. No. 10/820,233 (filed Apr. 5, 2004), all of which are incorporated herein by reference.

A display 24 (e.g., an LCD display) provides visual information to a user of the audio system through a user interface (e.g., a graphical user interface). The user interface includes a source indicator 26 that indicates the source currently being played by the audio system, which, in the example of FIG. 1, is the FM tuner. The user interface also includes an information window 27 that displays further information about the source and/or audio content currently playing, which, in the example of FIG. 1, the information window 27 shows the call letters of the FM station (WZLX), the FM frequency of the station (100.7 MHz), and the genre of the station (Rock).

System 20 also includes a cable 36 that connects the system to a portable audio device 32, such as an iPod® or other mp3 player, a cell phone, or portable digital assistant. The portable audio device 36 includes digital content, such as music (or audio) files and metadata, (e.g., song title, artist, album, genre, etc.) associated with each music file. In this example, the portable device includes a display 33 for presenting visual information and a control area 35 for controlling operation of the device.

The cable 36 connects to the portable audio device 32 in the glove box 34 of the automobile. In other implementations, however, the portable audio device may be connected through inserting the portable audio device through a slot in the dashboard of the vehicle, such as described in co-pending application Ser. No. 11/145,168 filed on Jun. 3, 2005 which is incorporated herein by reference. In non-automobile implementations, the portable audio device may be connected to an audio system via an external or integrated docking cradle. In addition, other implementations may wirelessly connect the portable audio device to the system 20 by, for example, a Bluetooth A2DP wireless link.

Referring again to FIG. 1, the portable audio device 32 includes a display 33 for presenting visual information and a control area 35 for controlling operation of the device. A dashed line 34 represents a glove box of an automobile. Device 32 has been placed in the glove box 34 but has not yet been operatively connected to audio system 20 by a connector cable (electrical conductor) 36. Connector cable 36 is part of an interface unit. At this point device 32 is in a play mode and is playing the song “Goodbye Earl” by the Dixie Chicks (see display 33). Device 32 could also he in pause mode at this point.

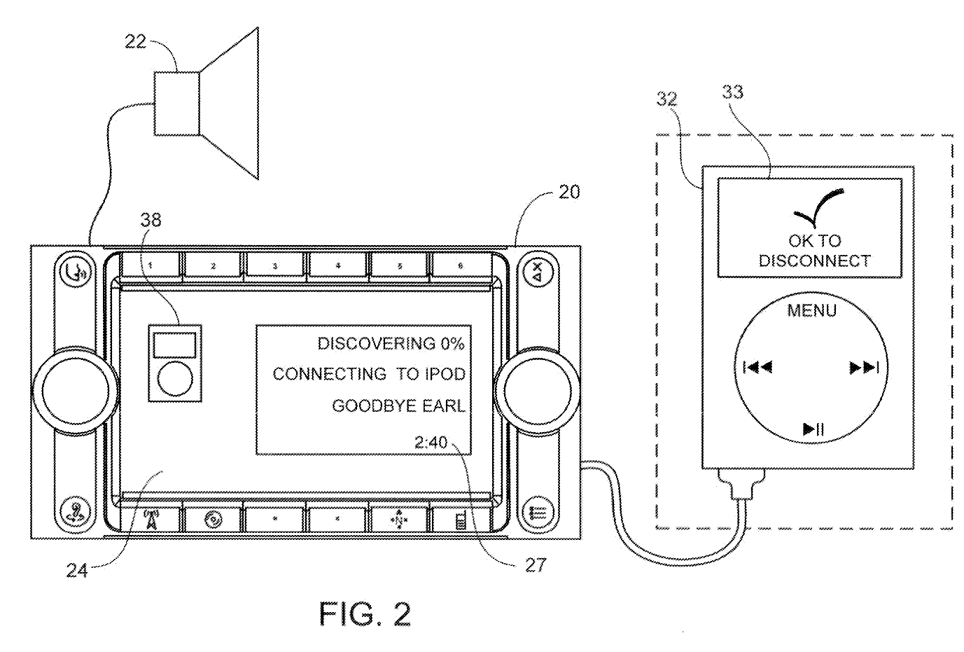

Turning to FIG. 2, now cable 36 has been connected to portable audio device 32. Upon connection, the audio system 20 immediately recognizes that the portable audio device has been connected and automatically switches from playing a previous audio source (e.g., FM tuner) to playing content from the portable audio device. In this embodiment the portable device is preferably in play or pause mode when it is connected to cable 36. This switch is visually indicated on the user interlace by the source indicator 38 changing from FM (shown in FIG. 1) to an icon representing the portable audio device (shown in FIG. 2). Also upon connection, the display 33 on the portable device indicates that it is “OK To Disconnect”. At any point portable device 32 can be safely disconnected from audio system 20. It should be noted that when portable device 32 is disconnected from cable 36, the audio system reverts to using the original source of audio data (e.g. FM tuner) that was playing prior to the portable device being connected to supply audio data to speaker 22 to produce sound.

Additionally, the information window 27 of the user interface shows that the audio system 20 has recognized connection of the portable audio device and provides information about the audio content currently being played (“Goodbye Earl” and 2:40 time left until the end of the song). The information window 27 also shows the state of a discovery process in which the audio system 20 is discovering the content stored on the portable audio device 32, which in this example, shows that, audio system 20 is “Connecting To iPod” and has “Discovered 0%” of the portable device's metadata.

In the discovery process, die audio system 20 connects to the portable music device and automatically downloads (or discovers) the metadata stored on portable device 32. Metadata is well known by those skilled in the art and includes information about each song such as artist, album, genre, playtime etc. The audio system 20 downloads the complete set of metadata for all audio content on portable device 32 and stores it in random access memory (RAM), a volatile memory, and/or on the hard disk (a non-volatile memory) of audio system 20. For a volatile memory a trickle current can continue to be supplied to the memory when the audio system is shut down in order to prevent the metadata from being lost from the volatile memory. In a car audio system, this trickle current would be supplied by the car battery.

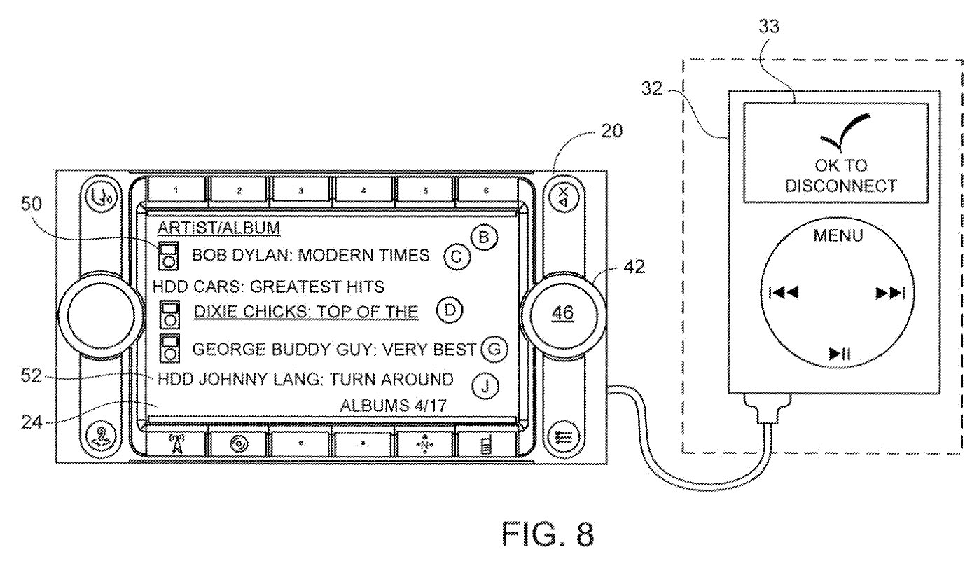

Storing the metadata on the hard disk (or other local storage device) provides the following advantage. When the portable device is disconnected and then reconnected to audio system 20, the audio device cheeks a “fingerprint” of the portable device to see if it is the same portable device as the previous portable device to be connected to the audio system. The fingerprint is checked by (a) looking at the name (identifier) assigned to the portable device by its owner or manufacturer, (b) looking at the total number of albums, artists and tracks stored on the portable device, and (c) checking some random strings in the metadata such as the first and last song stored on the portable device. If it is determined from the fingerprint that the same portable device has been connected to the audio system as the previous portable device that was connected, and the total number of tracks stored on the portable device has not changed, then the metadata from the portable device is not re-downloaded to the audio system. If it is determined from the fingerprint that a different portable device has been connected to the audio system, or that the same portable device has been connected but with changed metadata, then all of the metadata on the connected portable device is downloaded to the audio system. This feature can greatly decrease the time and processing power it takes for the portable device to connect to the audio system. Additionally, downloading the metadata to the audio system 20 allows the system 20 to render content selection menus of the audio content stored on the portable audio device in a manner consistent with how the system 20 renders content selection menus from other stores of audio content (e.g., music files stored on a local hard drive or music files on a different portable audio device). See FIG. 8 for a representation of this feature.

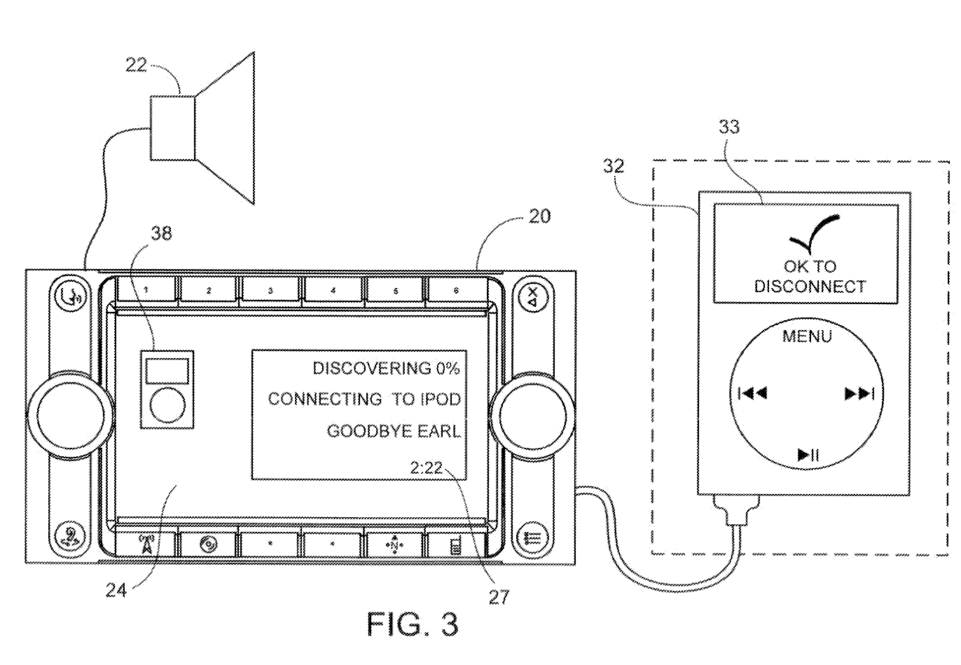

Referring to FIG. 3, the information window 27 now indicates that the discovery process has reached a point at which 50% of the metadata from portable device 32 has now been downloaded (discovered) to RAM in the audio system. “Goodbye Earl” is still being played and there are now 2:22 of time left on this song.

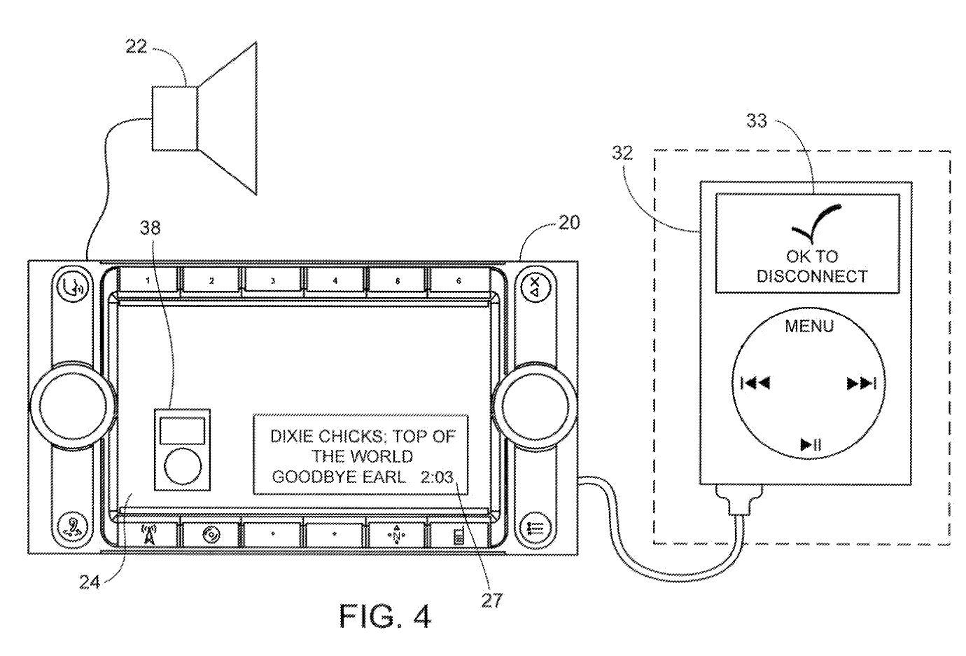

As shown in FIG. 4, all of the metadata from portable device 32 has been downloaded to RAM in audio system 20 and the information window 27 now reflects information only about the current song being played (here, the song “Goodbye Earl” by the “Dixie Chicks” from their album “Top of the World” with 2:03 of time remaining). It should be noted that while in this particular example the discovery process only downloaded and stored metadata to the audio system, in other implementations, a discovery may download and store the actual audio content.

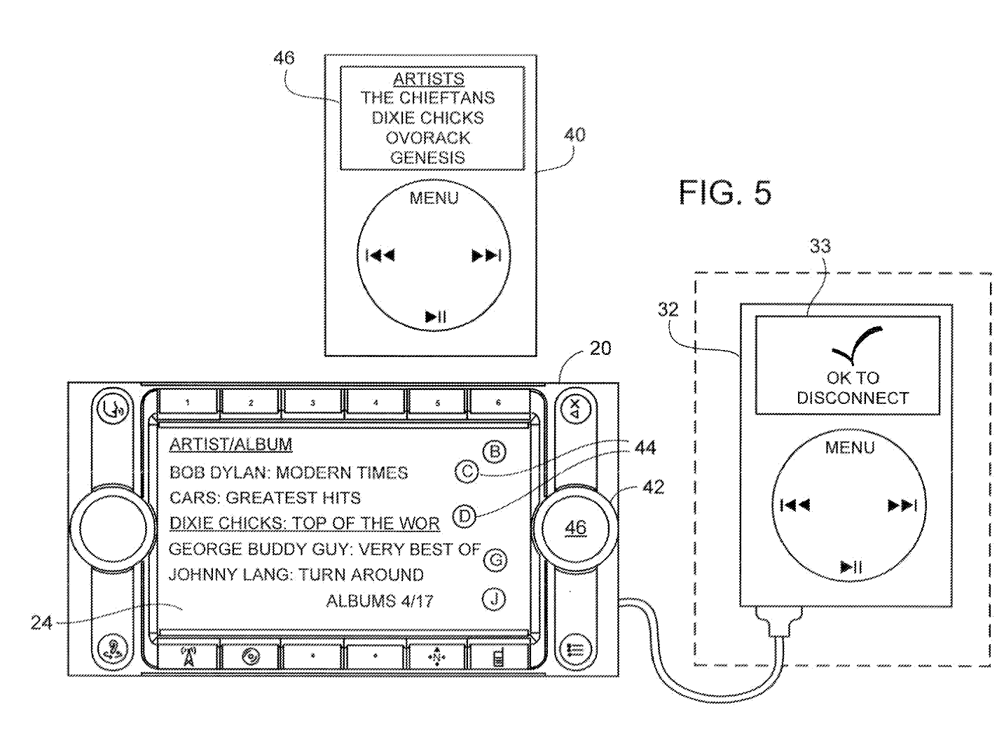

As shown in FIG. 5-7, portable audio device 32 is shown operating in stand-alone mode as well as connected to audio system 10 to illustrate that system 20 may present source selection menus via its user interface in a manner that is different to how portable audio device 32 presents its source selection menus.

Referring again to FIG. 4, if a listener would like to change from listening to “Goodbye Earl” to another song, they would rotate an outer knob 42 on the audio system. This causes the information to be displayed in display 24 as shown in FIG. 5. By rotating knob 42 letters 44 are caused to rotate on the display in the same direction as the direction of knob rotation. These letters represent the first letter of the name of the artist.

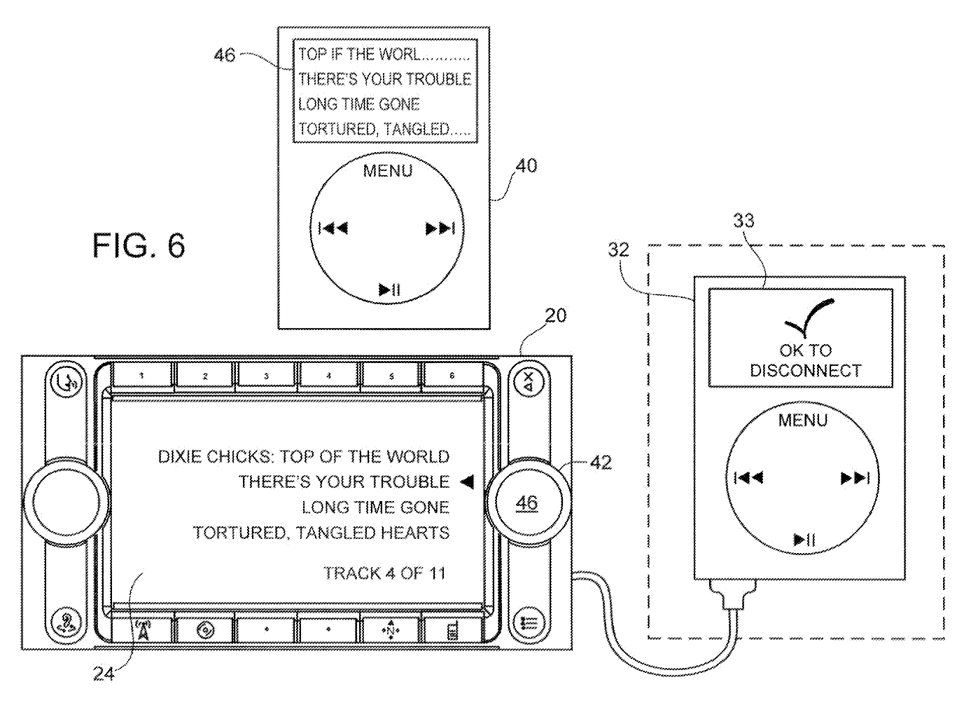

By comparing the information on a display 46 of portable device 32 in stand-alone mode with the information on display 24 shown in FIG. 5, it can be seen, that metadata is presented on display 24 in a format which is different from a corresponding format in which the metadata is displayed on display 46. In display 46 only the artists are presented. In display 24, both the artist and an album of that artist are displayed. Also, the total albums (17) and the point in the list of albums (4/17) are displayed. If the listener decides they want to listen to the Dixie Chicks' album “Top of the World”, they press a knob 46. As represented in FIG. 6, this action causes a new set of information to be presented on display 24. Again, metadata is presented on display 24 in a format which is different from a corresponding format in which the metadata is displayed on display 46. On display 46 only the title of the album “Top of the World” is displayed, whereas on display 24 the name of the artist (Dixie Chicks) is also displayed in addition to the album title. Further, the total tracks on the album (11) and the point in the list of tracks (4/11) are displayed. The listener would then rotate knob 46 in one direction or the other to select the desired track and then press knob 46 to start playing the selected track. This aspect of the disclosure applies to an audio system that does not have its own source of audio because it relates to how metadata from the portable device is presented on its display verses the display of the audio system. For example, this aspect of the invention can be used with a powered speaker that has a display and which can be operatively connected to a portable device. This comment also applies to the disclosure of the next paragraph.

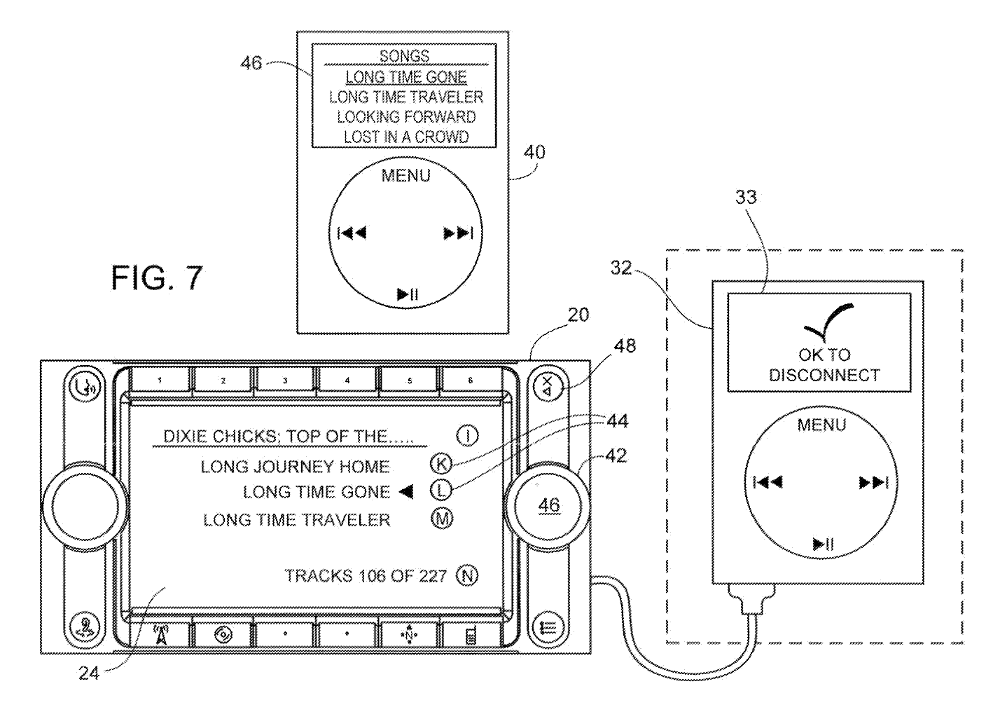

Turning to FIG. 7, if a listener wants to see an entire list of tracks that are stored on portable audio device 32, they would press a button 48. This causes display 24 to present a choice of organizing the metadata by artist/album or by track (not shown in the drawings). The listener would then rotate knob 46 to select organizing by track and then press a knob 48 to exit that screen. This action causes display 24 to present the metadata shown in FIG. 7. Here all of the tracks or organized alphabetically. A listener rotates knob 42 which causes letters 44 are caused to rotate on the display in the same direction as the direction of knob rotation. Here the listener has rotated knob 42 to select tracks that start with the letter “L”. To move within the “L” tracks the listener rotates knob 46. It should be noted that knob 46 can be rotated to move to another letter such as “K” or “M”. Knob 42 is a macro rotation knob and knob 46 is a micro rotation knob. Currently the track “Long Time Gone” is selected. In order to play this song the listener would press knob 46. The artist and album (Dixie Chicks/Top of the World) for the selected track are listed at the top of the screen. Further, the total number of tracks (227) and the point (order) in the list of tracks (106) are displayed. Again, metadata is presented on display 24 in a format which is different from a corresponding format in which the metadata is displayed on display 46. Display 46 does not provide the name of the artist or album for the selected track. Nor does display 46 present the total number of tracks (songs) or the order in the list of tracks.

As shown in FIG. 8, the display is similar to what is shown in the example of FIG. 5. Here, however, artists/albums are presented on display 24 which are stored on both portable device 32 and a hard disk drive of audio system 20. In other words, metadata for audio files stored on the portable audio source device and metadata for audio files stored on the audio system are simultaneously presented on display 24. A symbol 50 is located to the left of artists/albums that reside on portable device 32, and a symbol 52 (“HDD”) is located to the left of artists/albums that reside on the hard disk drive of the audio system. Thus, a user is conveniently able to access content stored on two (or more) separate sources (e.g., a local hard drive and a portable audio device) through a single menuing system. The metadata for audio files stored on the portable device is presented on display 24 in the same format as the metadata for audio files stored on the audio system. This is true whether the metadata for the two sources of audio files are displayed simultaneously as in FIG. 8 or not.

This same consolidated presentation can be used when in the list of tracks mode as shown in FIG. 7. Symbol 50 or 52 is placed next to each track to indicate where the track is stored. This arrangement provides a user interface configured to present a single menu that allows a user to select a song from either a first plurality of songs stored on the hard disk drive of the audio system or a second plurality of songs stored on portable device 32 without having to change source selection.

Audio system 20 also includes a song selection module (not shown) that plays back songs stored on either the hard drive or portable audio device without user input, the song selection module may use the locally stored metadata (associated with local content and external content) to randomly select and play songs stored on either the local hard drive or portable audio device. Alternatively, the song selection module may use the locally stored metadata (associated with local content and external content) to intelligently select songs from either source for playback. The song selection module may use any known intelligent selection algorithms to select songs based on implicit and/or explicit user feedback, such as those described in U.S. patent application Ser. No. 10/180,900 filed on Jun. 25, 2002 which published on Dec. 25, 2003 as 2003/0236582, and which is incorporated herein by reference.

While the invention has been particularly shown and described with reference to specific exemplary embodiments, it is evident that those skilled in the art may now make numerous modifications of, departures from and uses of the specific apparatus and techniques herein disclosed. Consequently, the invention is to be construed as embracing each and every novel feature and novel combination of features presented in or possessed by the apparatus and techniques herein disclosed and limited only by the spirit and scope of the appended claims.

What is claimed is:

1. A method of selecting an audio source, comprising tire steps of:
providing a vehicle audio system that includes a head unit for an automobile infotainment system, the head unit including a source of audio data which can be supplied to a speaker to produce sound; and
enabling a portable audio source device to be operatively connected to the audio system, whereby when the portable audio source device is operatively connected to the head unit, the audio system automatically stops supplying audio data from the source of audio data to the speaker and starts supplying audio data from the portable audio scarce device to the speaker to produce sound.

2. The method of claim 1, wherein the portable audio source device is operatively connected to the audio system with an electrical conductor.

3. The method of claim 1, wherein the portable audio source device is operatively connected to the audio system wirelessly.

4. The method of claim 1, wherein when the portable device is disconnected from the audio system, the audio system reverts to using the source of audio data to supply audio data to the speaker to produce sound.

5. The method of claim 1, wherein the source of audio data is selected from one of FM, AM, satellite radio, CD, DVD, and navigation system.

6. The method of claim 1, wherein the portable audio source device is an iPod®.

7. A method of downloading metadata, comprising the steps of:
providing an audio system; and
enabling a portable audio source device to be operatively connected to the audio system, whereby when the portable audio source device is operatively connected to the audio system, metadata stored on the portable audio source device is automatically downloaded to the audio system.

8. The method of claim 7, wherein the portable audio source device is operatively connected to the audio system with an electrical conductor.

9. The method of claim 7, wherein the portable audio source device is operatively connected, to the audio system wirelessly.

10. The method of claim 7, wherein the downloaded metadata is stored in a volatile memory of the audio system.

11. The method of claim 10, wherein the volatile memory is random access memory.

12. The method of claim 7, wherein the downloaded metadata is stored in a non-volatile memory of the audio system.

13. The method of claim 12, wherein the non-volatile memory is a hard disk drive.

14. The method of claim 7, wherein downloaded metadata that is saved by the audio system is not re-downloaded when the portable device is disconnected from the audio system and then again operatively connected to the audio system.

15. The method of claim 13, wherein downloaded metadata that is saved by the audio system is not re-downloaded when it is determined that the metadata stored on the portable device has not changed from when the portable device was connected to the audio system to when the portable device was next connected to the audio system.

16. A method of presenting metadata, comprising the steps of:
providing an audio system that includes a display; and
enabling a portable audio source device to be operatively connected to the audio system, whereby after the portable audio source device is operatively connected to the audio system, metadata for audio files stored on the portable audio source device is presented on a display of the audio system in a format which is different from a format in which the metadata is displayed on a display of the portable audio source device.

17. The method of claim 16, wherein the metadata presented on the portable device display lists the name of each artist but does not list the name of an album for each artist, whereas the metadata presented on the audio system display lists the name of each artist and lists the name of the album for each artist.

18. The method of claim 17, wherein the metadata presented on the portable device display does not list the total number of albums stored on the portable device, whereas the metadata presented on the audio system display lists the total number of albums stored on the portable device.

19. The method of claim 17, wherein the metadata presented on the portable device display does not list an order of a selected album among a total number of albums stored on the portable device, whereas the metadata presented on the audio system display lists the order of a selected album among the total number of albums stored on the portable device.

20. The method of claim 16, wherein the metadata presented on the portable device display lists the name of each track on an album but does not list the name of an artist for that album, whereas the metadata presented on the audio system display lists the name of each track on the album and lists the name of the artist for that album.

21. The method of claim 20, wherein the metadata presented on the portable device display does not list the total number of tracks on the album, whereas the metadata presented on the audio system display lists the total number of tracks on the album.

22. The method of claim 20, wherein the metadata presented on the portable device display does not list an order of a selected track among a total number of tracks on the album, whereas the metadata presented on the audio system display lists the order of a selected track among the total number of tracks or the album.

23. The method of claim 16, wherein the metadata presented on the portable device display lists the name of each track stored on the portable device but does not list the name of an artist for a selected one of the tracks, whereas the metadata presented on the audio system display lists the name of each track stored on the portable device and lists the name of the artist for the selected track.

24. The method of claim 23, wherein the metadata presented on the portable device display does not list the total number of tracks stored on the portable device, whereas the metadata presented on the audio system display lists the total number of tracks stored on the portable device.

25. The method of claim 23, wherein the metadata presented on the portable device display does not list an order of a selected track among a total number of tracks stored on the portable device, whereas the metadata presented on the audio system display lists the order of a selected track among the total number of tracks stored on the portable device.

26. A method of presenting metadata, comprising the steps of:
providing an audio system that includes a display; and
enabling a portable audio source device to be operatively connected to the audio system, whereby after the portable audio source device is operatively connected to the audio system, metadata associated with an audio file stored on the portable audio source device and metadata associated with an audio file stored on the audio system are simultaneously presented on the display.

27. The method of claim 26, wherein an indicator is provided on the display for a particular piece of metadata that indicates whether an audio file associated with that metadata is stored on the portable device, or whether the audio file is stored on the audio system.

28. The method of claim 26, wherein metadata for audio files stored on the portable device is stored on the audio system in a non-volatile memory of the audio system.

29. The method of claim 28, wherein the non-volatile memory is a hard disk drive.

30. An audio system comprising:
a storage device for digitally storing a first plurality of songs and metadata associated with each of the first plurality of songs;
an interface unit for interfacing with a portable audio source device having a second plurality of songs and metadata associated with each of the second plurality of songs; and
a user interlace configured to present a single menu that allows a user to select a song from either the first or second plurality of songs without having to change source selection.

31. The method of claim 30, wherein an indicator is provided on a display of the user interface for a particular piece of metadata that indicates whether an audio file associated with that metadata is stored on the portable device, or whether the audio file is stored on the storage device.

32. The method of claim 30, wherein metadata for audio files stored on the portable device is stored on the storage device in a non-volatile memory.

33. The method of claim 32, wherein the non-volatile memory is a hard disk drive.

34. An audio system comprising:
a storage device for digitally storing a first plurality of songs and metadata associated with each of the first plurality of songs;
an interlace unit for interfacing with a portable audio source device having a second plurality of songs and metadata associated with each of the second plurality of songs; and
a song selection module configured to playback songs from either the first or second plurality of songs without user input.

35. The audio system of claim 34, wherein the song selection module randomly selects songs from among the first and second plurality of songs.

36. The audio system of claim 34, wherein the song selection module intelligently selects songs from among the first and second plurality of songs.

37. A method of presenting metadata, comprising the steps of:
providing an audio system that includes a display; and
enabling a portable audio source device to be operatively connected to the audio system, whereby after the portable audio source device is operatively connected to the audio system, metadata associated with an audio file stored on the portable audio source device and metadata associated with an audio file stored on the audio system are presented on the display in substantially the same format.

38. The method of claim 37, wherein metadata associated with the audio file stored on the portable audio source device and metadata associated with the audio file stored on the audio system are presented on the display at substantially the same time.

39. The method of claim 37, wherein the format is different from a format in which metadata is displayed by the portable device.
